(19) United States
(12) Patent Application Publication
(10) Pub. No.: US 2006/0017859 A1
(43) Pub. Date: Jan. 26, 2006

(54) Image display device having slim type cathode ray tube

(76) Inventors: Han-Wook Choi, Suwon-si (KR); Chul-Woo Kim, Suwon-si (KR)

Correspondence Address: CHRISTIE, PARKER & HALE, LLP, PO BOX 7068, PASADENA, CA, 91109-7068, US

(21) Appl. No.: 11/153,033

(22) Filed: Jun. 14, 2005

(30) Foreign Application Priority Data
Jul. 21, 2004 (KR) 10-2004-0056939

(51) Int. Cl. H04N 5/645

(52) U.S. Cl. 348/825; 248/917

(57) ABSTRACT

An image display device includes a cathode ray tube for displaying images, a case enclosing the cathode ray tube while forming the outer appearance thereof, and a support partially receiving the cathode ray tube and connected to the case to support the case. The support includes: a post, with one end portion connected to the case, a support portion tightly fitted to the case to support the case, and a portion proceeding substantially vertical to the ground surface; and a base connected to the post to stand the post erect.

### CROSS-REFERENCE TO RELATED APPLICATION

This application claims the benefit of and priority to Korean Patent Application No. 10-2004-0056939, filed on Jul. 21, 2004 in the Korean Intellectual Property Office, the entire disclosure of which is incorporated herein by reference.

### FIELD OF THE INVENTION

The present invention relates to an image display device, and in particular, to an image display device which uses a cathode ray tube as an image display unit.

### BACKGROUND OF THE INVENTION

Generally, a cathode ray tube (CRT) is an electron tube which deflects electron beams, emitted from an electron gun, horizontally and vertically. The electron beams land on a screen including light-emitting phosphor layers resulting in displaying the desired images. The deflection of the electron beams is performed by a deflection yoke, which is mounted around the outer circumference of a funnel, and creates a formation of horizontal and vertical magnetic fields.

The cathode ray tube has been mainly used in producing color televisions and computer monitors, and has recently been used in high-end products, such as high definition television (HDTV).

However, with recent technological developments, flat panel displays, such as plasma display panels, liquid crystal displays, and organic field emission displays, have been spotlighted as the choice of displays, rather than displays using cathode ray tubes, which have an excellent display quality, but have a large vacuum tube. The large vacuum tube occupies a large space and is heavy due to its large size.

In regard to this, the cathode ray tube industry has made efforts to reduce the weight of the vacuum tube as much as possible, while maintaining reasonable air-proof strength thereof, and to shorten the electric field length, thereby slimming the cathode ray tube.

Such image display device where a cathode ray tube is used as the display unit, which does not make any significant difference in space usage compared to flat panel displays, appeals to consumers.

However, consumers have gradually turned their face away from image display devices using a cathode ray tube, because the electric field length of the cathode ray tube cannot be sufficiently reduced, due to the structural limitation thereof, compared to flat panel displays, even though it involves excellent brightness characteristics and low production costs.

Furthermore, when an image display device with a cathode ray tube is utilized as a television, it is set only with a case enclosing the entire cathode ray tube. However, in this case, no special visual sensation is provided to the consumers, and hence, it does not satisfy the various preferences of the consumers.

In addition, when the image display device is installed on the same level as the eye of the consumers at the locations of usage (e.g., in a living room, or other locations), it is typically put on a separate support stand, which is at least equal in size to the cathode ray tube. In this case, the support stand also occupies a large space and is a burden to the user.

### SUMMARY OF THE INVENTION

In one embodiment, the present invention is an image display device having a cathode ray tube which reduces its total installation area compared to the screen size, and satisfies the preferences of consumers for the overall appearance.

According to one aspect of the present invention, an image display device includes: a cathode ray tube for displaying images; a case enclosing the cathode ray tube while forming the outer appearance thereof; and a unitary support including a cavity for partially receiving the cathode ray tube while being connected to the case to suspend it.

In one embodiment, the support has a support portion fitted to the center of the case to support it.

Specifically, the case includes front and back case parts arranged at the front and rear of the cathode ray tube and connected to each other, and one end portion of the support is connected to the center of the back case part.

According to another aspect of the present invention, an image display device includes: a cathode ray tube for displaying images; a case enclosing the cathode ray tube while forming the outer appearance thereof; and a support partially receiving the cathode ray tube and connected to the case to suspend it. The support includes: a post, having one end portion connected to the case, a support portion tightly fitted to the case to support it, and a portion proceeding substantially vertical to the ground surface; and a base connected to the post to stand it erect.

In one embodiment, the post has a first curved portion partially connected to the case, and a second portion connected to the first portion and fitted to the base in an erect standing state. The case support portion may be formed in the first portion.

According to still another aspect of the present invention, an image display device includes: a cathode ray tube for displaying images; a case enclosing the cathode ray tube while forming the outer appearance thereof; and a support partially receiving the cathode ray tube and connected to the case to suspend it. The support includes: a post having one end portion connected to the case, and a support portion tightly fitted to the case to support it and inclined at an angle with respect to the direction vertical to the ground surface; and a base connected to the post to stand it erect.

In one embodiment, both ends of the base are branched, and the suspension distance of the case is shorter than the length of any one edge of the case. According to yet another aspect of the present invention, an image display device includes a cathode ray tube for displaying images; a case for enclosing the cathode ray tube; and a support having for partially receiving the cathode ray tube, wherein footprint of the case has a substantially same size as a footprint of the support.

### BRIEF DESCRIPTION OF THE DRAWINGS

FIG. 1 is a front perspective view of an image display device, according to a first embodiment of the present invention.

FIG. 2 is a front view of the image display device, according to the first embodiment of the present invention.

FIG. 3 is a side view of the image display device, according to the first embodiment of the present invention.

FIG. 4 is a rear perspective view of the image display device, according to the first embodiment of the present invention.

FIG. 5 is a front perspective view of an image display device, according to a second embodiment of the present invention.

FIG. 6 is a front view of the image display device, according to the second embodiment of the present invention.

FIG. 7 is a side view of the image display device, according to the second embodiment of the present invention.

FIG. 8 is a rear perspective view of the image display device, according to the second embodiment of the present invention.

### DETAILED DESCRIPTION

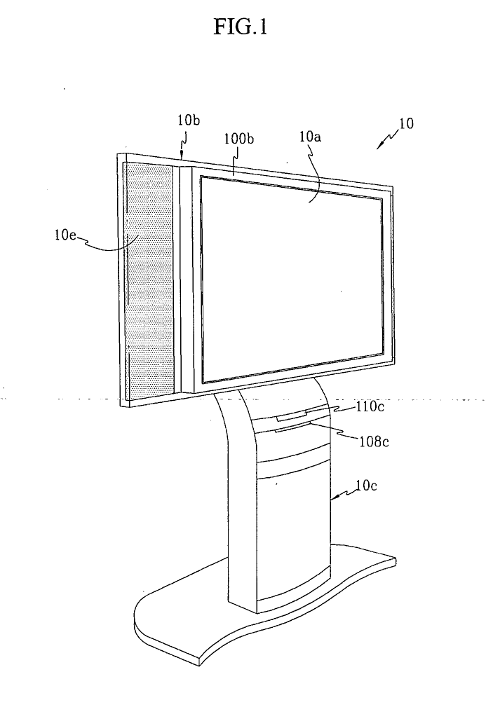

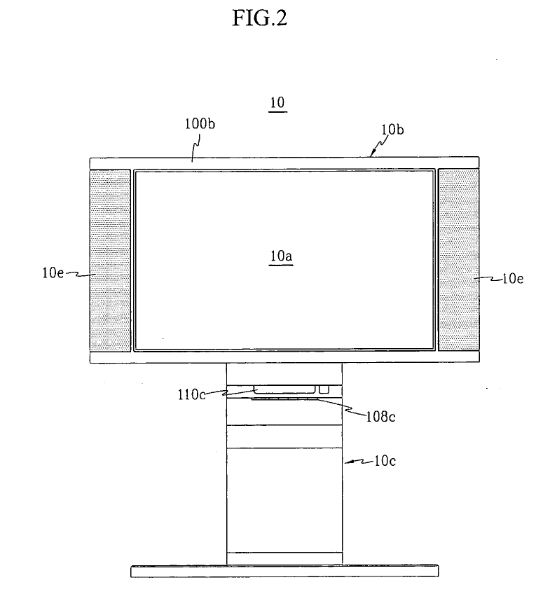

FIGS. 1 to 4 are different views of an image display device, according to a first embodiment of the present invention.

The image display device according to the present invention is an electronic device where a cathode ray tube is used as a display unit. Since the basic structural components of the cathode ray tube are similar to a typical cathode ray tube, a detailed explanation thereof will be omitted.

As shown in FIG. 1, the image display device 10 includes a cathode ray tube 10a, a case 10b enclosing the cathode ray tube 10a and combined with the cathode ray tube 10a, and a support 10c connected to the case 10b to suspend it. In one embodiment, the cathode ray tube is a slim type cathode ray tube with a shortened electric field length. In order to have a smaller image display device, this slim type cathode ray tube requires a support stand that is optimized in size and does not require a substantially larger space than the slim cathode ray tube.

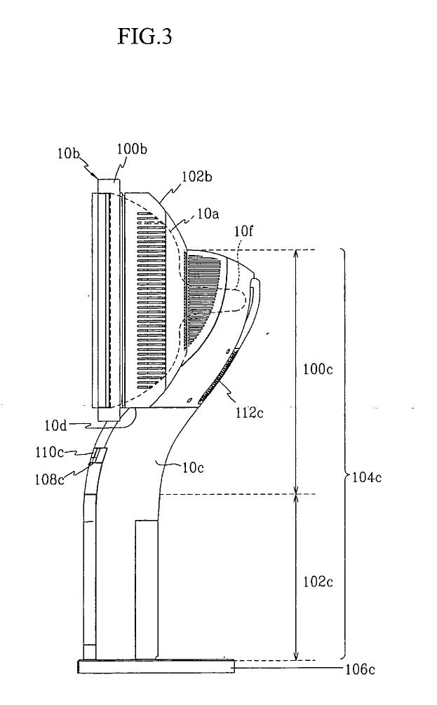

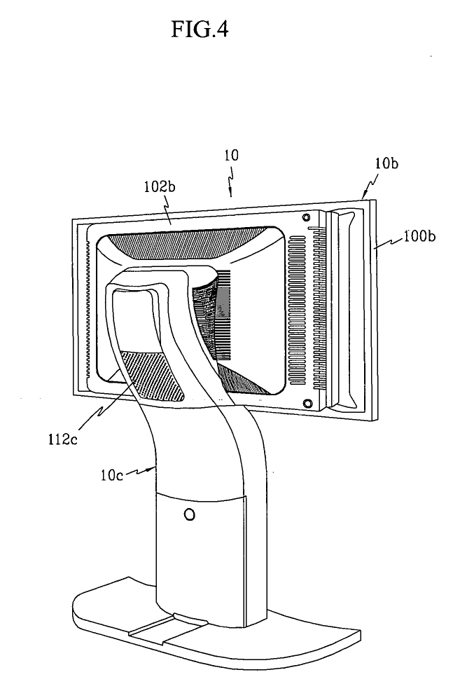

The case 10b makes a formation of the outer appearance of the image display device 10, and includes a front case part 100b placed at the front of the cathode ray tube 10a, and a back case part 102b (shown in FIGS. 3 and 4) placed at the rear of the cathode ray tube 10a, which are coupled to each other by way of a screw coupling (not shown).

The support 10c is connected at one end to the center of the back case part 102b by way of a screw coupling, while supporting the case 10b to be at the same level as the eye level of the user. In this embodiment, the support 10c is a stand-type support.

As shown in FIG. 3, the support 10c has a post 104c with a first portion 100c connected at one end to the center of the back case part 102b, and a second portion 102c connected to the first portion 100c while standing substantially vertical to the ground surface.

The post 104c is connected to a base 106c, and supported by the latter, thereby maintaining the erect standing state thereof.

In this embodiment, as shown in FIG. 3, the first portion 100c is curved, and placed at the front (below) and the rear of the case 10b. The first portion 100c has a support portion 10d (for example, a platform) on which the case 10b is positioned and fitted. The platform may have a leveled (horizontal) top surface or an angled top surface. The first portion 100c also includes a cavity in which a portion of the CRT 10a, for example, a neck portion is positioned.

When the case 10b and the support 10c are coupled to each other, the body portion of the cathode ray tube 10a is placed within the case 10b, and the neck portion 10f with an electron gun (not shown) mounted therein, is placed within the cavity of the first portion 100c of the support 10c. It is noted that for the support 10e to have a stable standing position when the CRT 10a and the case 10b are placed thereon, the weight of the CRT and case combination is distributed in such a way to have the center of the gravity of the CRT and case combination substantially centered with respect to second portion 102c and base 106c.

In one embodiment, the footprint of the case including the slim cathode ray tube 10a is substantially the same size as the footprint of the support mainly, because the neck portion of the cathode ray tube 10a is placed within the cavity of support 10c. This way, the size of the image display device is not substantially increased by including the support 10c with the device.

The above arrangement relation is derived from the fact that the electric field length of the slim cathode ray tube 10a is significantly reduced compared to a conventional cathode ray tube with the same screen size. (In this embodiment, the cathode ray tube has a screen size of 32 inches, and a screen ratio of 16:9, but it is not necessarily limited thereto).

In this embodiment, the electric field length of the slim cathode ray tube 10a is substantially 35 cm, and the electric field length of the cathode ray tube 10a with the case 10b and the support 10c is 38 cm (compared to 60 cm for the same kind of conventional devices). Therefore, the case and the support stand are also reduced in size.

In one embodiment, the support 10c includes a DVD player and/or a video cassette recorder (VCR), embodied therein. For user convenience, insertion holes 108c and 110c are formed at the front of the support 10c to receive a DVD, a CD, or a video tape. Also, a ventilation hole 112c is provided at the rear of the support 10c to emit the heat generated during operation of the cathode ray tube 10a, from the support 10c. Alternatively or in addition, such a ventilation hole may be formed in the case 10b.

In addition, speakers 10e are arranged at both sides of the front case part 100b.

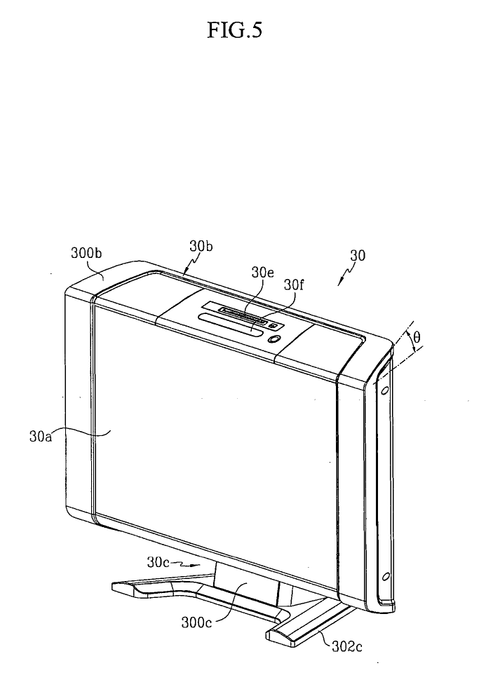

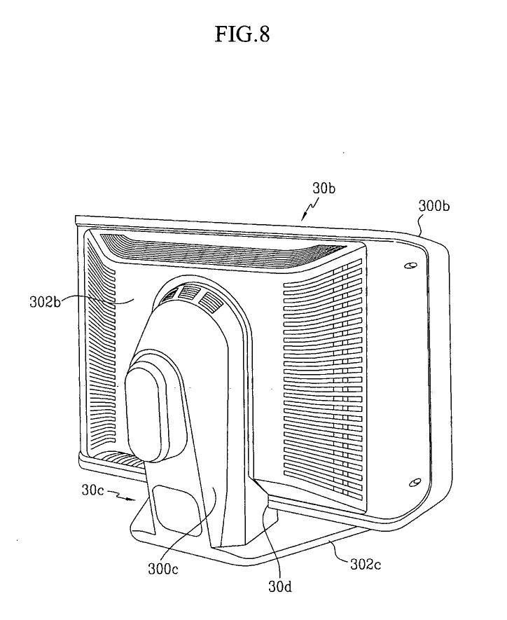

FIGS. 5 to 8 illustrate an image display device according to a second embodiment of the present invention.

The image display device 30 includes a slim type cathode ray tube 30a for displaying images, a case 30b enclosing the cathode ray tube 30a while forming the outer appearance thereof, and a support 30c connected to the case 30b to support it.

The case 30b has a front case part 300b and a back case part 302b, which are arranged at the front and rear of the cathode ray tube 30a, and combined with each other by way of, for example, a screw coupling. In one embodiment, the support 30c is a mount-type support.

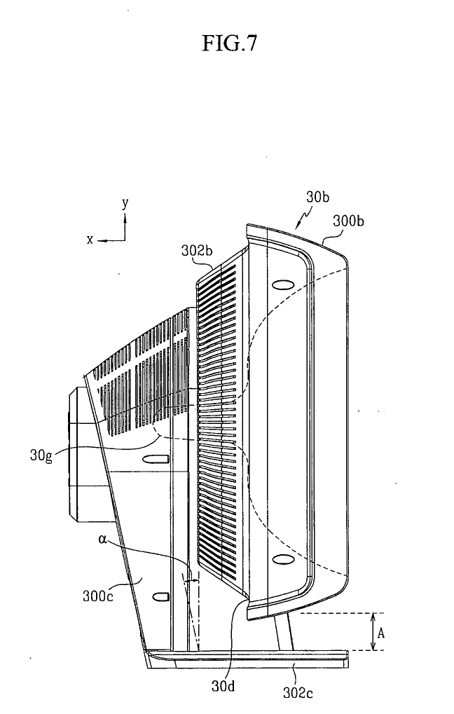

As shown in FIG. 7, the body portion of the cathode ray tube 30a is placed within the case 30b, and the neck portion 30g is placed within a cavity formed in the support 30c.

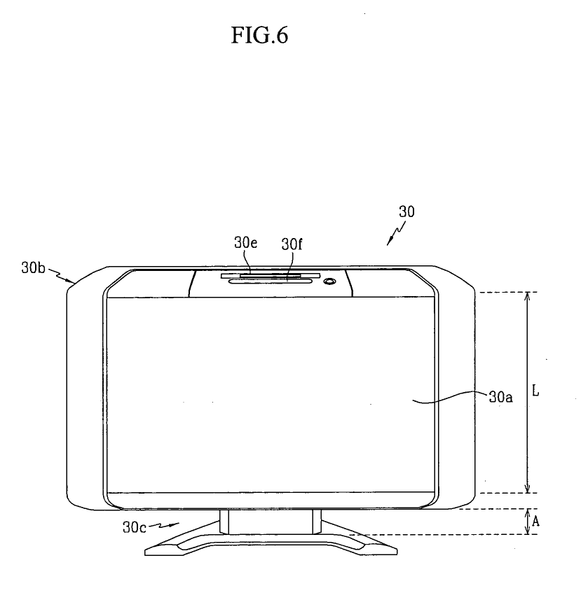

In the second embodiment, the support 30c is entirely formed with a post 300c, inclined at an angle of a with respect to the y direction vertical to the ground surface. A base 302c is connected to a post 300c to have the support 30c standing erect. The suspension distance A of the case 30b becomes shorter than L, the length of any one edge of the case 30b from the support 30c, as shown in FIG. 6.

In one embodiment, the post 300c is screw-coupled at its one side to the center of the back case part 302b. As shown in FIGS. 5 and 6, the base 302c is branched at both sides thereof. The portion of the support 30c, in which the cathode ray tube 30a is partially placed, is the top portion of the post 300c (based on the drawing).

Moreover, the post 300c has a support portion 30d (for example, a platform) fitted to the case 30b to support it, as shown in FIG. 7. The platform may have a leveled (horizontal) top surface or an angled top surface.

In one embodiment, the support 10c includes a DVD player and/or a video cassette recorder (VCR), embodied therein. As depicted in FIG. 6, with the image display device 30a, insertion holes 30e and 30f are formed at the top surface of the front case part 300b to receive a DVD, a CD, or a video tape. For user convenience, the insertion holes 30e and 30f are tilted at an angle of β (not shown) with respect to the ground surface.

The characteristics of the slim cathode ray tube 30a used in the second embodiment are similar to those related to the previous embodiment, and hence, a detailed explanation thereof will be omitted.

As described above, with the inventive image display device, the electric field length of the cathode ray tube is reduced (because of its slim size), and a case and a support for supporting the case are constructed in conformity with the slim size of the cathode ray tube. Consequently, the installation area of the image display device is significantly reduced, and the preferences of the user are well satisfied compared with flat panel displays.

Furthermore, the support for holding the case, with the slim cathode ray tube mounted therein, makes it possible to easily place the image display device at the usage location in conformity to the eye of the user, thereby serving to enhance the user satisfaction.

In addition, the inventive image display device involves beautiful and fine designs, and gives esthetic sensation to the consumers, thereby enhancing the quality thereof.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. An image display device comprising:
a cathode ray tube for displaying images;
a case for enclosing the cathode ray tube while forming an outer appearance thereof; and
a unitary support having a cavity for partially receiving the cathode ray tube while being connected to the case to support the case.

2. The image display device of claim 1, wherein the support has a support platform fitted to the case to support the case.

3. The image display device of claim 1, wherein the support is connected to the center of the case to support the case.

4. The image display device of claim 3, wherein the case comprises front and back case parts arranged at the front and rear of the cathode ray tube and connected to each other, and one end portion of the support is connected to the center of the back case part.

5. The image display device of claim 1, wherein a ventilation hole is formed in a portion of the support.

6. An image display device comprising:
a cathode ray tube for displaying images;
a case for enclosing the cathode ray tube; and
a support partially receiving the cathode ray tube and connected to the case to support the case,
wherein the support comprises a post, having one end portion connected to the case, a projected platform fitted to the case to support the case, a portion proceeding substantially vertical to the ground surface, and a base connected to the post to stand the post erect.

7. The image display device of claim 6 wherein the post comprises a first curved portion partially connected to the case, and a second portion connected to the first portion and fitted to the base in an erect standing state.

8. The image display device of claim 7, wherein the projected platform is formed in the first portion.

9. The image display device of claim 6, wherein a ventilation hole is formed in the post.

10. The image display device of claim 6, wherein one or more insertion holes are formed in the post to receive a DVD, a CD, or a video tape.

11. The image display device of claim 6, wherein the case comprises front and back case parts arranged at the front and rear of the cathode ray tube and connected to each other, and one end portion of the post is connected to the center of the back case part.

12. An image display device comprising:
a cathode ray tube for displaying images;
a case for enclosing the cathode ray tube while forming an outer appearance thereof; and
a support partially receiving the cathode ray tube and connected to the case to support the case,
wherein the support comprises a post, having one end portion connected to the case, a projected platform fitted to the case to support the case while being inclined at an angle with respect to the direction vertical to the ground surface, and a base connected to the post to stand the post erect.

13. The image display device of claim 12, wherein both sides of the base are branched.

14. The image display device of claim 12, wherein the case comprises front and back case parts arranged at the front and rear of the cathode ray tube and connected to each other, and one end portion of the post is connected to the center of the back case part.

15. The image display device of claim 14, further comprising a DVD player or a video cassette player and wherein one or more insertion holes are formed in the front case part to receive a DVD, a CD, or a video tape.

16. The image display device of claim 15, wherein the portion of the front case part with the insertion holes is inclined at an angle with respect to the ground surface.

17. The image display device of claim 12, wherein the suspension distance of the case is shorter than the length of any one edge of the case.

18. An image display device comprising:
a cathode ray tube for displaying images;
a case for enclosing the cathode ray tube; and
a support having for partially receiving the cathode ray tube, wherein footprint of the case has a substantially same size as a footprint of the support.

19. The image display device of claim 18, further comprising a DVD player or a video cassette player for playing a DVD, a CD, or a video tape, and one or more insertion holes in the case for receiving the DVD, CD, or video tape.

20. The image display device of claim 18, wherein the support includes a cavity for receiving a neck of the cathode ray tube.
